(19) United States
(12) Patent Application Publication
(10) Pub. No.: US 2013/0076805 A1
(43) Pub. Date: Mar. 28, 2013

(54) DISPLAY DEVICE AND CONTROL METHOD OF THE SAME

(71) Applicant: Japan Display East Inc., Mobara-shi (JP)

(72) Inventors: Kenta KAJIYAMA, Yotsukaido (JP); Hajime Akimoto, Kokubunji (JP)

(73) Assignee: Japan Display East Inc., Mobara-shi (JP)

(21) Appl. No.: 13/629,776

(22) Filed: Sep. 28, 2012

(30) Foreign Application Priority Data
Sep. 28, 2011 (JP) 2011-213406

(51) Int. Cl. G09G 5/10

(52) U.S. Cl. CPC G09G 5/10
USPC 345/690

(57) ABSTRACT

Provided is a display device and a control method of the same which suppress the occurrence of color separation. The display device includes: a light source of plural kinds of colors; a plurality of elements which are provided to a plurality of pixels respectively, and change over transmission/non-transmission of light emitted from the light source; and a control part which expresses gray levels of the respective pixels by color sequential driving in which the presence/non-presence of lighting of the light source and the transmission/non-transmission of light by the elements are sequentially controlled. The control part fetches image data amounting to 1 screen and performs a display based on the image data for every image data use period, and performs a display of an image amounting to 1 screen for every frame display period. The frame display period differs from the image data use period in length.

### CROSS-REFERENCE TO RELATED APPLICATION

The present application claims priority from Japanese application JP 2011-213406 filed on Sep. 28, 2011, the content of which is hereby incorporated by reference into this application.

### BACKGROUND OF THE INVENTION

1. Field of the Invention

The present invention relates to a display device and a control method of the same, and more particularly to a gray level display using elements which change over the transmission/non-transmission of light.

2. Description of the Related Art

JP 2008-197668 A discloses a display device where a minute shutter referred to as MEMS (Micro Electro Mechanical System) shutter is provided to respective pixels. Such a display device adopts a field sequential color (color sequential driving) method where the pixels of plural kinds of colors are sequentially turned on.

### SUMMARY OF THE INVENTION

Such a display device which adopts the color sequential driving method has a drawback that color separation occurs. Color separation is a phenomenon where when a line having a white and black tone is moved, front and rear sides of the line are tinted with colors.

FIG. 18 is a view showing an image for illustrating an example of color separation. The image is an image which displays a white strip line having a predetermined width on a black background. As an example of turning on a light source within a 1 frame display period by a color sequential driving method, there has been known a case where the 1 frame display period during which an image amounting to 1 screen is displayed is divided into 3 pieces of divided frame display periods (R, G, B), and a light source is sequentially turned on in the order of red (R), green (G) and blue (B) in each divided frame display period (for example, see FIG. 15). When the image shown in FIG. 18 is scrolled from the right to the left, a red colored line appears on the left side of the strip line, and a blue colored line appears on the right side of the strip line.

To suppress such a phenomenon, there could be an example where a 1 frame display period is further finely divided into 6 pieces of divided frame display periods (R1, G1, B1, R2, G2, B2) and, in the same manner, a light source is sequentially turned on in the order of red (R), green (G) and blue (B) (for example, see FIG. 16). Also in this case, when the image shown in FIG. 18 is scrolled from the right to the left, although widths of red and blue colored lines are decreased, the red and blue colored lines appear. That is, although the widths of the colored lines are decreased by dividing the 1 frame display period more finely, the occurrence of color separation per se is not suppressed.

The present invention has been made in view of the above-mentioned circumstances and it is a main object of the present invention to provide a display device and a control method of the same which suppress the occurrence of color separation.

(1) To overcome the above-mentioned drawback, according to one aspect of the present invention, there is provided a display device including: a light source of plural kinds of colors; a plurality of elements which are provided to a plurality of pixels respectively, and change over transmission/non-transmission of light emitted from the light source; and a control part which expresses gray levels of the respective pixels by color sequential driving in which the presence/non-presence of lighting of the light source and the transmission/non-transmission of light by the elements are sequentially controlled. In the display device, the control part fetches image data amounting to 1 screen and performs a display based on the image data for every image data use period, and performs a display of an image amounting to 1 screen for every frame display period; and the frame display period differs from the image data use period in length.

(2) In the display device having the above-mentioned constitution (1), the control part may not use a part of the image data during the image data use period when the frame display period is longer than the image data use period, and the control part may use a part of the image data during the image data use period in a superposed manner when the frame display period is shorter than the image data use period.

(3) In the display device having the above-mentioned constitution (1) and (2), the frame display period may be constituted of n (n≧2) pieces of continuous divided frame display periods; a display in k (1≦k<n) pieces of continuous divided frame display periods may be performed during 1 image data use period; and during the 1 image data use period, the control part may not use a part of the image data to be used for a display in remaining (n−k) pieces of divided frame display periods.

(4) In the display device having the above-mentioned constitution (1) and (2), the frame display period may be constituted of n (n≧2) pieces of continuous divided frame display periods; a display in k (n<k<2n) pieces of continuous divided frame display periods may be performed during 1 image data use period; and during the 1 image data use period, the control part may use the image data amounting to 1 screen during 1 frame display period, and may further use a part of the image data which is used for a display in further succeeding (k−n) pieces of divided frame display periods.

(5) In the display device having the above-mentioned constitution (3), a display with only any one of the plural kinds of colors may be performed in the n pieces of continuous divided frame display periods respectively, and kinds of colors which are displayed during the n pieces of divided frame display periods may be sequentially repeated; and (n−k) may be smaller than the number of kinds of colors.

(6) In the display device having the above-mentioned constitution (4), a display with only any one of the plural kinds of colors may be performed in the n pieces of continuous divided frame display periods respectively, and kinds of colors which are displayed during the n pieces of divided frame display periods may be sequentially and repeatedly continued; and (k−n) may be smaller than the number of kinds of colors.

(7) In the display device having the above-mentioned constitution any one of (3) and (4), each of the n pieces of divided frame display periods may be constituted of 1 or plural sub frame periods, and a predetermined length of a light transmission period where transmission/non-transmission of light by the element is allowed may be determined with respect to the plurality of respective sub frame periods; the plurality of sub frame periods which constitute the frame display period may be classified into a first group to which the sub frame periods having light transmission periods of the same length belong and a second group to which the sub frame periods having light transmission periods which are shorter than the light transmission periods of the sub frame periods of the first group in length and differ from each other belong; and the plurality of sub frame periods belonging to the first group are arranged in the frame display period so that the number of sub frame periods having the light transmission periods may be increased toward a,start point and a finish point of the frame display period from a middle portion of the frame display period along with the elevation of the gray level; and each of the plurality of sub frame periods may include the plurality of light transmission periods in which lights of various kinds of colors transmit.

(8) In the display device having the above-mentioned constitution (7), the sub frame periods belonging to the first group and the sub frame periods belonging to the second group may be alternately provided.

(9) In the display device having the above-mentioned constitution (7), the sub frame periods belonging to the second group may be provided before and after the sub frame period having the light transmission period at the lowest gray level out of the sub frame periods belonging to the first group.

(10) According to another aspect of the present invention, there is provided a control method of a display device which includes: a light source of plural kinds of colors; a plurality of elements which are provided to a plurality of pixels respectively, and change over transmission/non-transmission of light emitted from the light source; and a control part which expresses gray levels of the respective pixels by color sequential driving in which the presence/non-presence of lighting of the light source and the transmission/non-transmission of light by the elements are sequentially controlled. In the display device, the control part may fetch image data amounting to 1 screen and perform a display based on the image data for every image data use period, and perform a display of an image amounting to 1 screen for every frame display period; and the frame display period may differ from the image data use period in length.

(11) In the control method of a display device having the above-mentioned constitution (10), the control part may not use a part of the image data during the image data use period when the frame display period is longer than the image data use period, and the control part may use a part of the image data during the image data use period in a superposed manner when the frame display period is shorter than the image data use period.

(12) In the control method of a display device having the above-mentioned constitution any one of (10) and (11), the frame display period may be constituted of n (n≧2) pieces of continuous divided frame display periods; a display in k (1≦k<n) pieces of continuous divided frame display periods may be performed during 1 image data use period; and during the 1 image data use period, the control part may not use a part of the image data to be used for a display in remaining (n−k) pieces of divided frame display periods.

(13) In the control method of a display device having the above-mentioned constitution any one of (10) and (11), the frame display period may be constituted of n (n≧2) pieces of continuous divided frame display periods; a display in k (n<k<2n) pieces of continuous divided frame display periods may be performed during 1 image data use period; and during the 1 image data use period, the control part may use the image data amounting to 1 screen during 1 frame display period, and may further use a part of the image data which is used for a display in further succeeding (k−n) pieces of divided frame display periods.

(14) In the control method of a display device having the above-mentioned constitution (12), a display with only any one of the plural kinds of colors may be performed in the n pieces of continuous divided frame display periods respectively, and kinds of colors which are displayed during the n pieces of divided frame display periods may be sequentially repeated; and (n−k) may be smaller than the number of kinds of colors.

(15) In the control method of a display device having the above-mentioned constitution (13), a display with only any one of the plural kinds of colors may be performed in the n pieces of continuous divided frame display periods respectively, and kinds of colors which are displayed during the n pieces of divided frame display periods may be sequentially and repeatedly continued; and (k−n) may be smaller than the number of kinds of colors.

(16) In the control method of a display device having the above-mentioned constitution any one of (12) and (13), each of the n pieces of divided frame display periods may be constituted of 1 or plural sub frame periods, and a predetermined length of a light transmission period where transmission/non-transmission of light by the element is allowed may be determined with respect to the plurality of respective sub frame periods; the plurality of sub frame periods which constitute the frame display period may be classified into a first group to which the sub frame periods having light transmission periods of the same length belong and a second group to which the sub frame periods having light transmission periods which are shorter than the light transmission periods of the sub frame periods of the first group in length and differ from each other belong; and the plurality of sub frame periods belonging to the first group are arranged in the frame display period so that the number of sub frame periods having the light transmission periods may be increased toward a start point and a finish point of the frame display period from a middle portion of the frame display period along with the elevation of the gray level; and each of the plurality of sub frame periods may include the plurality of light transmission periods in which lights of various kinds of colors transmit.

(17) In the control method of a display device having the above-mentioned constitution (16), the sub frame periods belonging to the first group and the sub frame periods belonging to the second group may be alternately provided.

(18) In the control method of a display device having the above-mentioned constitution (16), the sub frame periods belonging to the second group may be provided before and after the sub frame period having the light transmission period at the lowest gray level out of the sub frame periods belonging to the first group.

The present invention provides a display device and a control method of the same which suppress the occurrence of color separation.

### BRIEF DESCRIPTION OF THE DRAWINGS

FIG. 1 is a perspective view of a whole display device showing one example of an embodiment of the present invention;

FIG. 2 is a view showing a constitutional example of a glass substrate of the display device;

FIG. 3 is a view showing a constitutional example of a pixel of the display device;

FIG. 4 is a view showing a 1 frame display period during which an image amounting to 1 screen is displayed in a first embodiment of the present invention;

FIG. 5 is a view showing a driving sequence of an image display in the first embodiment of the present invention;

FIG. 6 is a view showing an image display according to the first embodiment of the present invention;

FIG. 7 is a view showing an image display according to a second embodiment of the present invention;

FIG. 8 is a view showing an image display according to a third embodiment of the present invention;

FIG. 9 is a view showing an image display according to a fourth embodiment of the present invention;

FIG. 10 is a view showing an image display according to a fifth embodiment of the present invention;

FIG. 11 is a view showing a driving sequence according to a sixth embodiment of the present invention;

FIG. 12 is a view showing the relationship between an image data use period and a frame display period according to the sixth embodiment of the present invention;

FIG. 13 is a view showing an image display according to the sixth embodiment of the present invention;

FIG. 14A to FIG. 14C are views showing an image for illustrating an example of color separation according to the sixth embodiment of the present invention;

FIG. 15 is a view showing an image display according to a comparison example 1 of the present invention;

FIG. 16 is a view showing an image display according to a comparison example 2 of the present invention;

FIG. 17 is a view showing an image display according to a comparison example 3 of the present invention; and

FIG. 18 is a view showing an image for illustrating an example of color separation.

### DETAILED DESCRIPTION OF THE INVENTION

Embodiments of a display device and a control method of the display device according to the present invention are explained in conjunction with drawings.

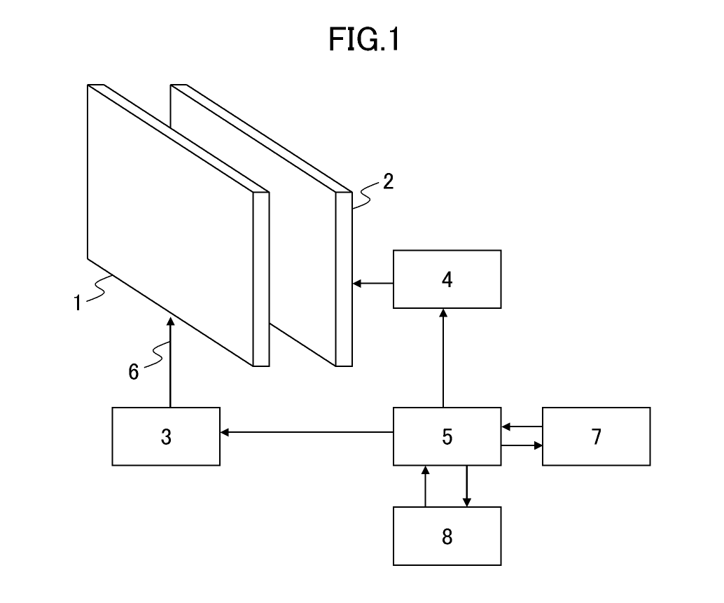

FIG. 1 is a perspective view of the whole display device showing one example of an embodiment of the present invention. The display device according to the present invention is a display device which makes use of lighting control elements such as MEMS shutters. The display device includes: a glass substrate 1; a backlight 2; a display control circuit 3, a light emission control circuit 4; a system control circuit 5 (control part); a frequency comparing block 7; and a frame memory 8. The glass substrate 1 includes the lighting control elements such as the MEMS shutters, and a pixel circuit and a peripheral circuit which drive the lighting control elements. The backlight 2 is a light source which illuminates a display region of the glass substrate 1, and includes LEDs of plural kinds of colors such as R, G and B. The display control circuit 3 controls circuits mounted on the glass substrate 1, and the light emission control circuit 4 controls the lighting of the backlight 2. The frequency comparing block 7 is a frequency comparator which compares a frequency for fetching an image signal (image data) (image data use period described later) and a frame frequency (frame display period described later). The frame memory 8 is an image frame memory, and image data fetched from the outside amounting to plural images is stored in the frame memory 8. The system control circuit 5 fetches an image signal (image data) from the frame memory 8 based on the frequency comparing block 7, and controls the display control circuit 3 and the light emission control circuit 4 based on the fetched image signal (image data).

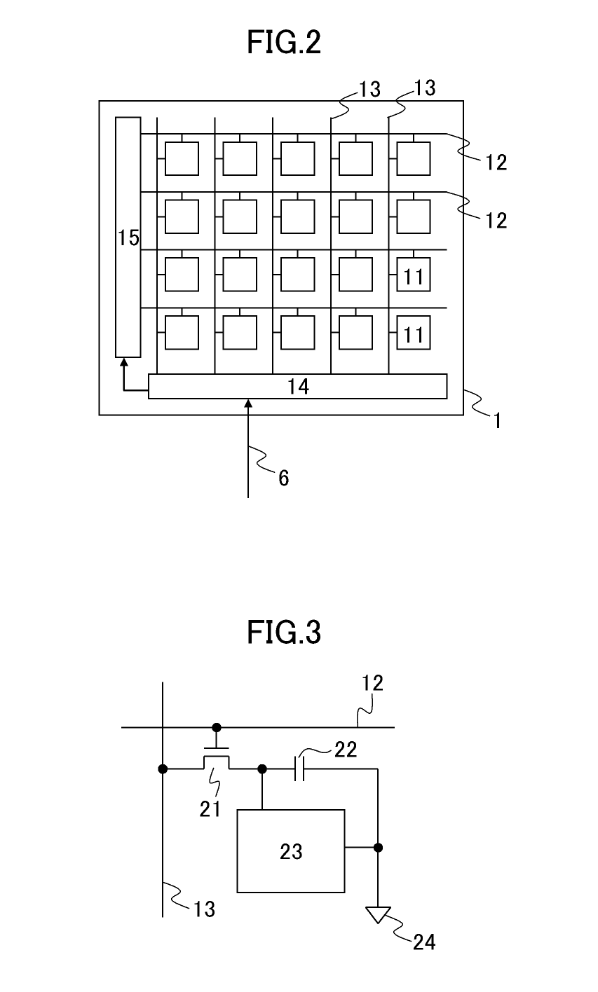

FIG. 2 is a view showing a constitutional example of the glass substrate 1 of the display device. A plurality of pixels 11, a row selection circuit 15 and an integrated circuit 14 are arranged on the glass substrate 1. The respective pixels 11 are arranged on the glass substrate 1 in a matrix array, and include the lighting control elements which change over the transmission/non-transmission of light emitted from the backlight 2 and a pixel circuit which drives the lighting control elements. Row selection signal lines 12 which extend from the row selection circuit 15 and data signal lines 13 which extend from the integrated circuit 14 are connected to the respective pixels 11. An image signal outputted from the integrated circuit 14 is stored in a storage capacitance of the pixel 11 selected by the row selection circuit 15. The row selection circuit 15 is controlled by the integrated circuit 14, and the integrated circuit 14 is controlled by the external display control circuit 3 via a control line 6 such as an FPC.

FIG. 3 is a view showing a constitutional example of the pixel 11 of the display device. A switch 21 is connected to the row selection signal line 12, and when the switch 21 is turned on, a voltage of the data signal line 13 is written in a storage capacitance 22. The storage capacitance 22 is connected between the switch 21 and a reference potential 24, and a lighting control element 23 is operated by the voltage written in the storage capacitance 22. The lighting control element 23 is an MEMS shutter or the like, and changes over the transmission/non-transmission of light emitted from the backlight 2. For example, the MEMS shutter is operated so as to open or close an aperture through which light emitted from the backlight 2 transmits.

Hereinafter, embodiments of a control method of a display device according to the present invention are explained.

### First Embodiment

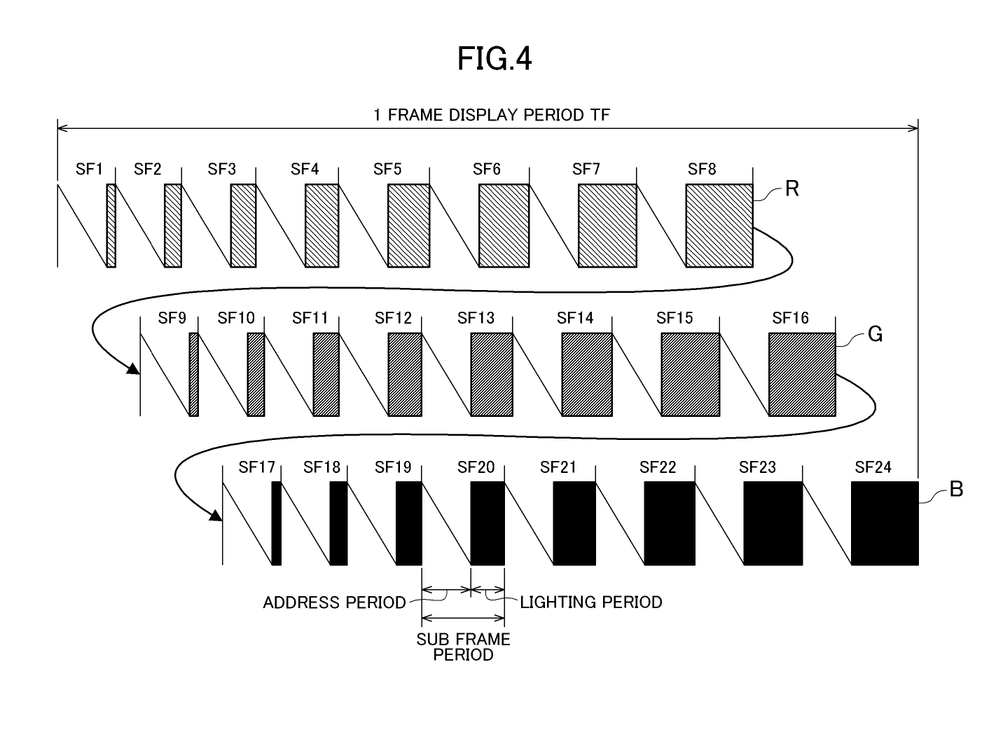

FIG. 4 is a view showing a 1 frame display period TF during which an image amounting to 1 screen is displayed in the first embodiment of the present invention. As shown in FIG. 4, the 1 frame display period TF is constituted of sub frame periods for R (SF1 to SF8), sub frame periods for G (SF9 to SF16) and sub frame periods for B (SF17 to SF24). Each sub frame period includes an address period and a lighting period. The address period is a period for writing data corresponding to the sub frame period out of image data amounting to 1 screen and for moving a shutter. Weighting is applied to a length of the lighting period included in each sub frame period in accordance with a binary number system. A gray level in each color of each pixel is expressed by controlling the transmission/non-transmission of light irradiated during such a lighting period using a shutter. Here, 256 gray levels can be expressed by 8 bits so that a gray level value takes integer values ranging from 0 to 255.

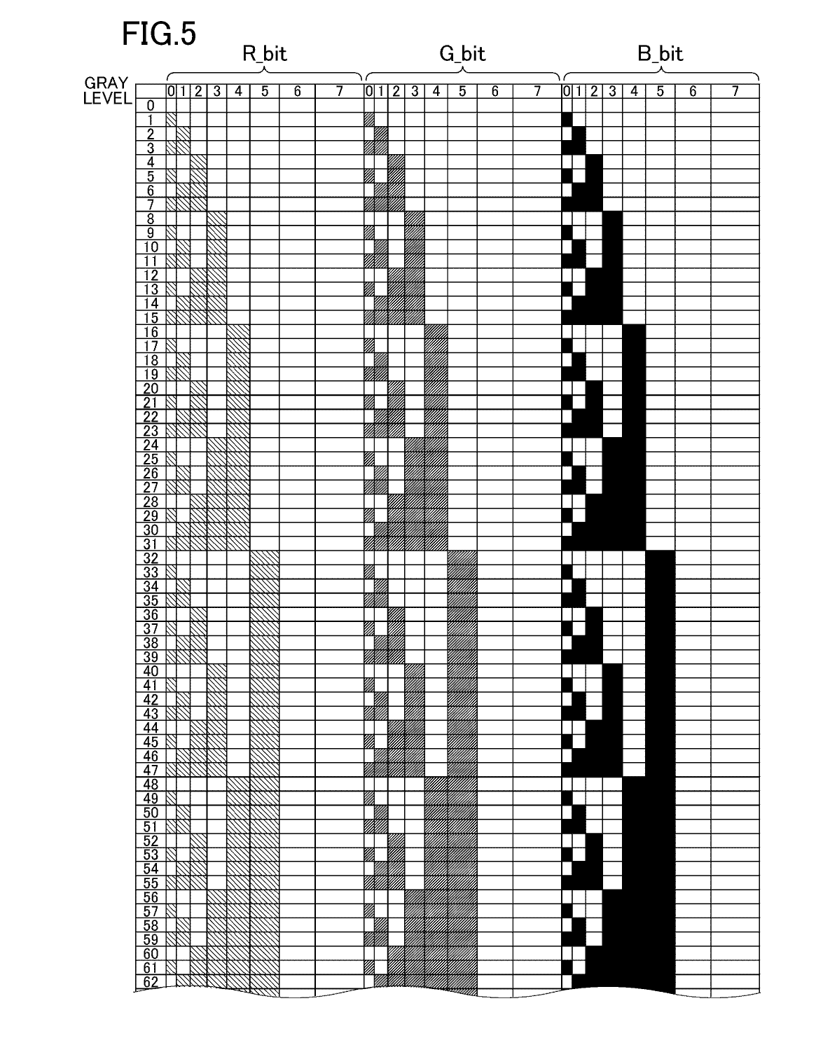

FIG. 5 is a view showing a driving sequence of an image display in this embodiment. A light transmission time is a period during which a light source is turned on and also a period during which the shutter is opened. In FIG. 5, a hatched cell or a black matted cell expresses the period during which the shutter is opened, and a white blank cell expresses a period during which the shutter is closed. Light emitted from the light source transmits through the aperture in the shutter open period, and the light emitted from the light source does not pass through the aperture in the shutter closed period.

In this embodiment, the 1 frame display period is divided into 3 pieces of divided frame display periods R, G, B, wherein the divided frame display period R is constituted of the sub frame periods of R (SF1 to SF8), the divided frame display period G is constituted of the sub frame periods of G (SF9 to SF16), and the divided frame display period B is constituted of the sub frame periods of B (SF17 to SF24) respectively.

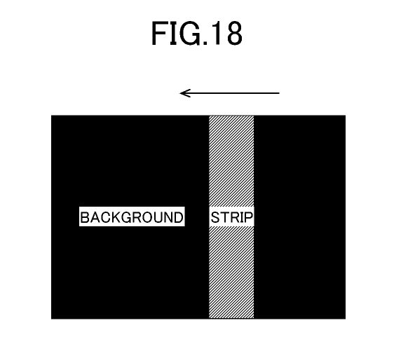

In place of the image shown in FIG. 18, for facilitating the understanding of the image, considered are three pixels PX1, PX2 and PX3 which are arranged from the right to the left. Assume that a predetermined width of the white strip line in the image shown in FIG. 18 amounts to one pixel. Also assume that a state where the image is scrolled from the right to the left is expressed by three pieces of image data, that is, data1, data2 and data3. Also assume that gray level information of each pixel in image data is expressed by gray level values of R, G, B (D_{R}, D_{G}, D_{B}). In the image data data1, the pixel PX1 performs a white display, and the pixel PX2 and the pixel PX3 perform a black display. In the image data data2, the pixel PX2 performs a white display, and the pixel PX1 and the pixel PX3 perform a black display. In the image data data3, the pixel PX3 performs a white display, and the pixel PX1 and the pixel PX2 perform a black display. Here, in expressing the white display and the black display by gray level values of RGB, the white display and the black display are expressed as (255, 255, 255) and (0, 0, 0) respectively.

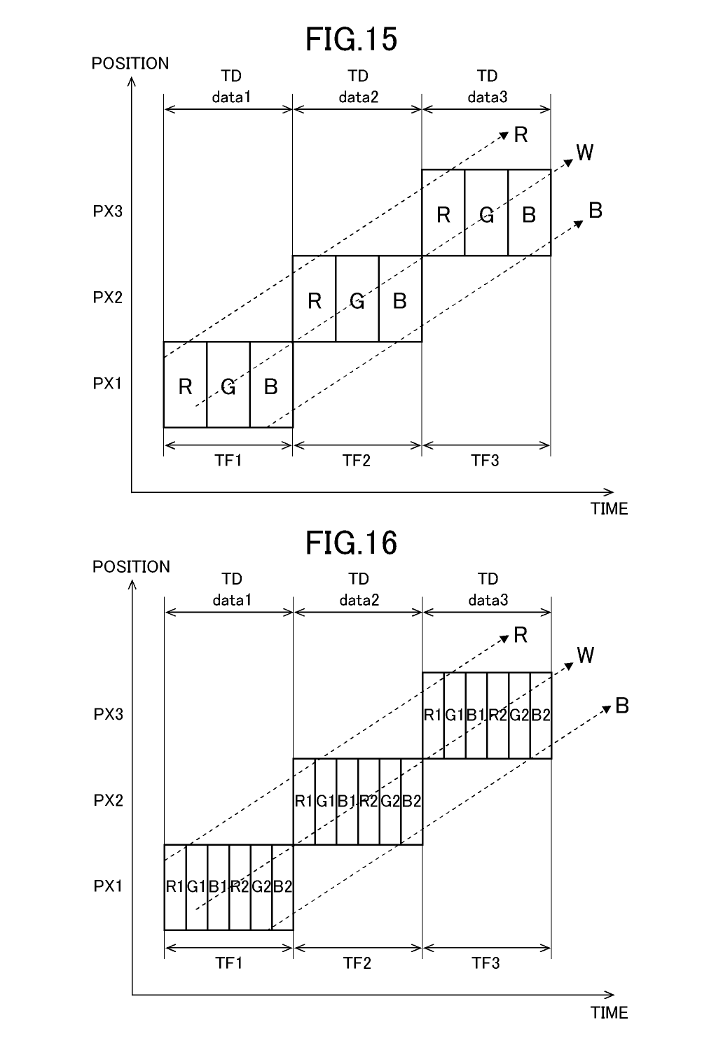

FIG. 15 is a view showing an image display according to a comparison example 1 for the present invention. A position of a pixel is taken on an axis of ordinates in the drawing, wherein the pixels PX1, PX2 and PX3 are sequentially arranged from the bottom to the top. A time is taken on an axis of abscissas in the drawing, wherein a 1 frame display period during which an image amounting to 1 screen is displayed is set as TF, and a first frame display period TF1, a second frame display period TF2, a third frame display period TF3, (a fourth frame display period TF4 . . . ) are time-sequentially set in this order. As described previously, the frame display period TF is constituted of 3 pieces of divided frame display periods R, G, B, and the divided frame display periods are sequentially repeated in the order of R, G, B as shown in FIG. 15. In the comparison example 1, image data amounting to 1 screen is fetched at frequency of 60 Hz (image data use period TD: 16.67 ms), and a display is performed based on the fetched image data. Image data amounting to 1 screen is displayed at frequency of 60 Hz. That is, the 1 frame display period TF is equal to the 1 image data use period TD, that is, 16.67 ms.

The display of the image data data1 is performed in the first frame display period TF1, the display of the image data data2 is performed in the second frame display period TF2, and the display of the image data data3 is performed in the third frame display period TF3. In this case, with respect to the image data use period TD (frame display period TF) during which each image data is used, the divided frame display period which is used first is R and the divided frame display period which is used last is B. Accordingly, as shown in FIG. 15, the R display is always performed when connecting the first divided frame display periods of respective image data, and the B display is always performed when connecting the last divided frame display periods of the respective image data. In the case of a control method which is constituted of the sub frame periods shown in FIG. 4, in a scroll state where the strip line moves, color to be displayed first in each image data always becomes red, and color to be displayed last in each image data always becomes blue. When the image shown in FIG. 18 is scrolled from the right to the left, a red colored line appears on a left side of the strip line, and a blue colored line appears on a right side of the strip line. A white display in the vicinity of the center of the strip line is indicated as W in FIG. 15.

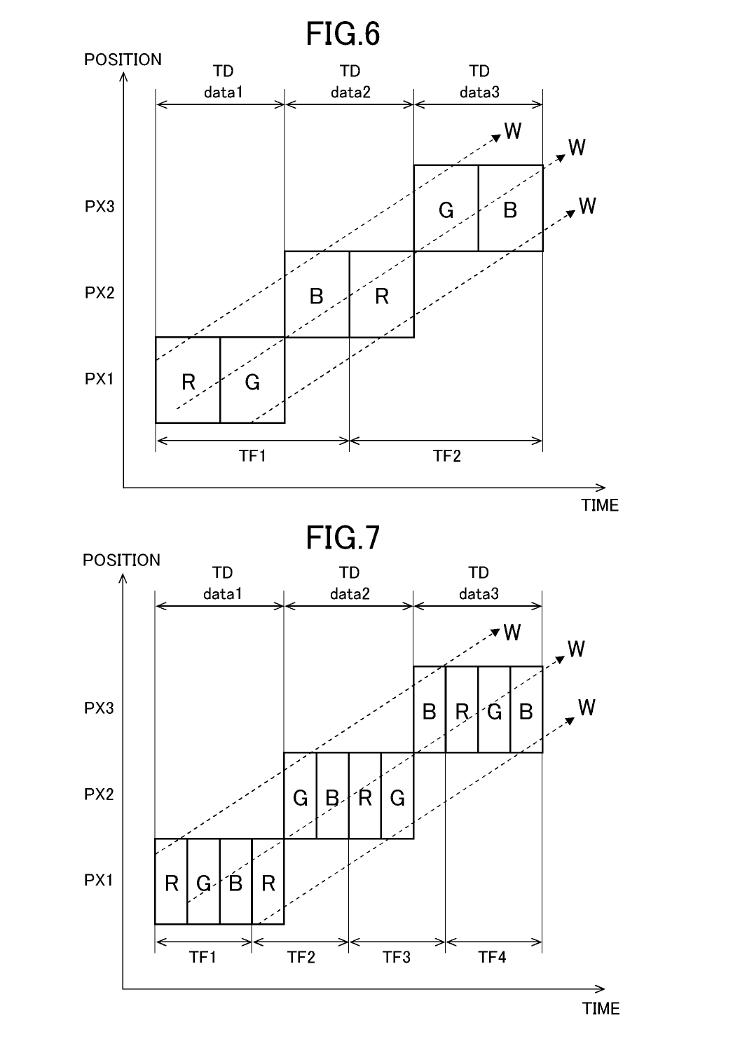

FIG. 6 is a view showing an image display according to the embodiment. In the same manner as FIG. 15, the position of a pixel is taken on an axis of ordinates in the drawing and time is taken on an axis of abscissas in the drawing. In the same manner as the comparison example 1, image data amounting to 1 screen is fetched at frequency of 60 Hz (image data use period TD: 16.67 ms), and the display is performed based on the fetched image data. However, this embodiment is different from the comparison example 1 in that a display is performed in only 2 pieces of divided frame display periods in a 1 image data use period TD. The 1 image data use period TD is shorter than a 1 frame display period TF (3 pieces of divided frame display periods) during which a display of an image amounting to 1 screen is performed so that the 1 image data use period TD and the 1 frame display period TF differ in length from each other. The 1 frame display period TF is 1.5 times as long as the 1 image data use period TD. That is, the 1 frame display period TF is 25 ms (frequency: 40 Hz).

In the same manner as the comparison example 1, each frame display period TF is constituted of 3 (n=3) continuous divided frame display periods R, G, B. However, this embodiment is different from the comparison example 1 in that the display in 2 (k=2, 1≦k<n) continuous divided frame display periods is performed during each image data use period TD. For example, during the image data use period TD where image data data1 is used, the display in 2 divided frame display periods R, G is performed, and the display in remaining 1 (n−k=1) divided frame display period B is not performed. Here, image information (a part of image data) used for the display in each divided frame display period is gray level information on color to be displayed in the divided frame display period out of gray level information of each pixel in image data. Accordingly, for example, during the image data use period TD where image data data1 is used, gray level information on R and G of each pixel in image data is used, and gray level information on B in the image data is not used. That is, during each image data use period TD, a part of image data is not used. Here, a part of image data which is not used means gray level information on color which is not displayed out of gray level information on three colors.

During the image data use period TD where image data data1 is used, using gray level information on two colors of R and G (without using gray level information on B), the display in the respective divided frame display periods R, G is performed. During the image data use period TD where image data data2 is used, using gray level information on two colors of B and R is used (without using gray level information on G), the display in the respective divided frame display periods B, R is performed. During the image data use period TD where image data data3 is used, using gray level information on two colors of G and B is used (without using gray level information on R), the display in the respective divided frame display periods G, B is performed. Accordingly, as shown in FIG. 6, when the first divided frame display periods of the respective image data are connected to each other, RBGRBG . . . is repeated, and the cumulative colors are recognized as white to a human eye whereby a red colored line which appears on a left side of the strip line is suppressed. In the same manner, when the last divided frame display periods on the respective image data are connected to each other, GRBGRB . . . is repeated so that a blue colored line which appears on a right side of the strip line is suppressed. All of the display on a left side of the strip line, the display in the vicinity of the center of the strip line and the display on the right side of the strip line are performed as W in FIG. 6.

In the control method according to this embodiment, the image data use period TD and the frame display period TF differ from each other so that the first (last) divided frame display period where image data is displayed differs between two pieces of continuous images. Accordingly, the occurrence of color separation could be suppressed. Further, during the image data use period TD where image data on a certain image is used, a part of the image data is not used so that a 1 divided frame display period could be prolonged whereby the number of data writing per unit time which is performed during an address period of each sub frame period could be decreased, or the number of switching the light emission of the light source per unit time could be reduced whereby light emission efficiency is enhanced and power consumption is decreased.

### Second Embodiment

FIG. 7 is a view showing an image display according to a second embodiment of the present invention. In the same manner as FIG. 6, a position of a pixel is taken on an axis of ordinates in the drawing, and time is taken on an axis of abscissas in the drawing. In the same manner as the first embodiment, a 1 image data use period TD is 16.67 ms. However, this embodiment is different from the first embodiment in that during the 1 image data use period TD, the display in 4 divided frame display periods is performed. The 1 image data use period TD is longer than a 1 frame display period TF so that the 1 image data use period TD and the 1 frame display period TF differ from each other in length. A part of image data is used in a superposed manner during 1 image data use period TD. The 1 frame display period TF is constituted of 3 (n=3) pieces of divided frame display periods, and the 1 frame display period TF is 0.75 times as long as the 1 image data use period TD. That is, the 1 frame display period TF is 12.5 ms (frequency: 80 Hz).

In this embodiment, during each image data use period TD, the display in 4 (k=4, n<k<2n) continuous divided frame display periods is performed. For example, during the image data use period TD where image data data1 is used, in addition to the display in the 1 frame display period TF (divided frame display periods R, G, B) where image data amounting to 1 screen is displayed, the display in a succeeding 1 (k−n) divided frame display period R is performed. In the image data use period TD where the image data data1 is used, the display in 3 divided frame display periods R, G, B is performed using all image data data1 (data amounting to 1 screen) and, further, the display in the divided frame display period R is performed using a part of the image data data1 so that gray level information on R (a part of image data) is used in a superposed manner.

During the image data use period TD where the image data data1 is used, in addition to the image display amounting to 1 screen (divided frame display periods R, G, B), the display in the divided frame display period R is performed using gray level information on R. During the image data use period TD where the image data data2 is used, in addition to the image display amounting to 1 screen (divided frame display periods G, B, R), the display in the divided frame display period G is performed using gray level information on G. During the image data use period TD where the image data data3 is used, in addition to the image display amounting to 1 screen (divided frame display periods B, R, G), the display in the divided frame display period B is performed using gray level information on B. Accordingly, as shown in FIG. 7, when the first divided frame display periods on the respective image data are connected to each other, RGBRGB . . . is repeated, and the cumulative colors is recognized as white to a human eye whereby a red colored line which appears on a left side of the strip line is suppressed. In the same manner, when the last divided frame display periods of the respective image data are connected to each other, RGBRGB . . . is repeated so that a blue colored line which appears on a right side of the strip line is suppressed. All of the display on the left side of the strip line, the display in the vicinity of the center of the strip line and the display on the right side of the strip line are performed as W in FIG. 7.

In the control method according to this embodiment, in the same manner as the first embodiment, the image data use period TD and the frame display period TF differ from each other so that the first (last) divided frame display period where image data is displayed differs between two pieces of continuous images. Accordingly, the occurrence of color separation could be suppressed. Further, the frame display period could be shortened compared to the image data use period TD and hence, the number of screens of an image to be displayed per unit time could be enhanced so that an image having a smoother movement could be displayed.

### Third Embodiment

A third embodiment of the present invention is different from the first embodiment in that a 1 frame display period TF is constituted of 6 pieces of divided frame display periods. That is, the display of each color is performed in 2 pieces of divided frame display periods. Each one of 2 pieces of divided frame display periods in which the display of each color is performed is constituted of 1 or a plurality of sub frame periods. The sub frame periods (SF1 to SF8) of R which perform the R display shown in FIG. 4 are classified into two groups, wherein the divided frame display period R1 is constituted of the sub frame periods classified into one group, and the divided frame display period R2 is constituted of the sub frame periods classified into the other group. It is desirable to classify the sub frame periods (SF1 to SF8) of R into two groups such that the lengths of two pieces of divided frame display periods are equal. Here, assume that the lengths of two pieces of divided frame display periods are equal. The 1 frame display period can be constituted of 6 pieces of divided frame display periods by constituting the sub frame periods in the same manner with respect to other colors.

FIG. 16 is a view showing an image display according to a comparison example 2 of the present invention. An axis of ordinates and an axis of abscissas in the drawing, and three image data data1, data2, data3 are set substantially in the same manner as the image display shown in FIG. 15. As described previously, the frame display period TF is constituted of 6 pieces of divided frame display periods R1, G1, B1, R2, G2, B2, and the divided frame display periods are sequentially repeated in the order of R, G, B as shown in FIG. 16. In the comparison example 2, in the same manner as the comparison example 1, an image data use period TD and a frame display period TF are equal in length. That is, both the lengths of the image data use period TD and the frame display period TF are 16.67 ms (frequency: 60 Hz).

Comparing the comparison example 2 with the comparison example 1 shown in FIG. 15, during the 1 frame display period TF, the number of divided frame display periods is increased twice so that the number of repetitions of R, G, B is also increased twice. However, with respect to the image data use period TD during which each image data is used, the divided frame display period which is used first is R1 and the divided frame display period which is used last is B2. Accordingly, in the same manner as the comparison example 1, the R display is always performed when connecting the first divided frame display periods of respective image data and the B display is always performed when connecting the last divided frame display periods of respective image data. Although a width of a colored line which appears in an image becomes short since the 1 divided frame display period is short, in the same manner as the comparison example 1, the color separation appears.

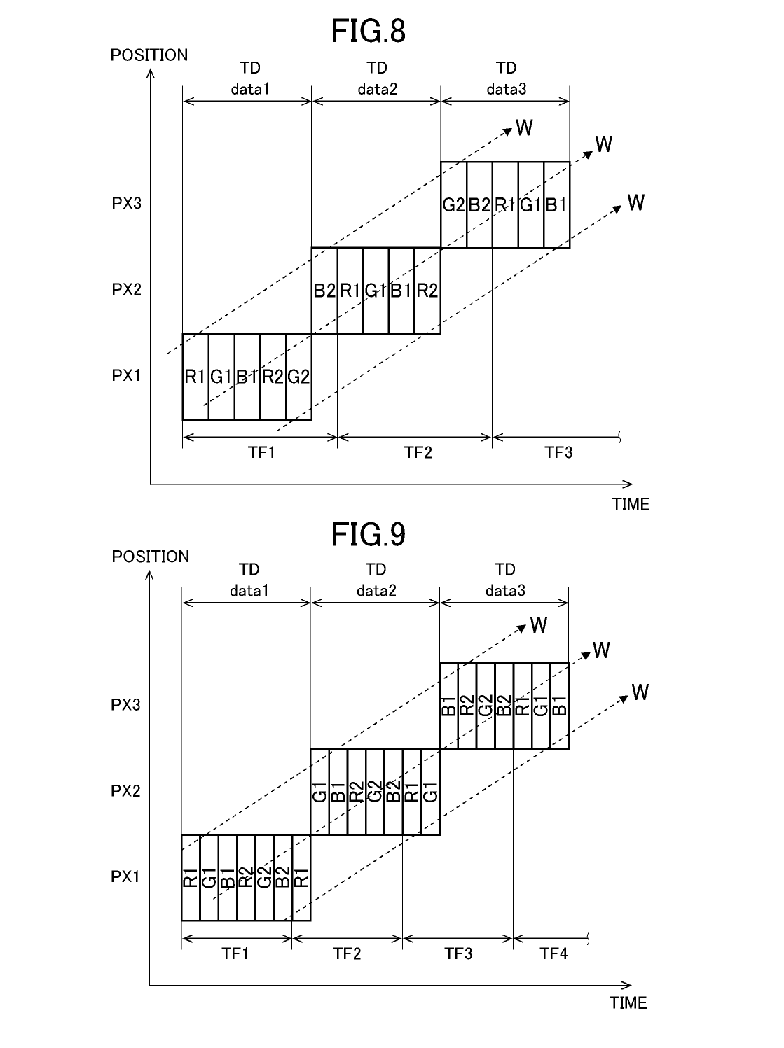

FIG. 8 is a view showing an image display according to this embodiment. An axis of ordinates and an axis of abscissas in the drawing, and three image data data1, data2, data3 are set substantially in the same manner as the image display shown in FIG. 6 and FIG. 7. In the same manner as the first embodiment, the 1 image data use period TD is smaller than the 1 frame display period TF (6 pieces of divided frame display periods), and a part of image data is not used in the 1 image data use period TD. The 1 image data use period TD is 16.67 ms (frequency: 60 Hz), and the 1 frame display period TF is 1.2 times as long as the 1 image data use period TD, that is, 20 ms (frequency: 50 Hz).

In the same manner as the comparison example 2, each frame display period TF is constituted of 6 (n=6) continuous divided frame display periods. However, this embodiment is different from the comparison example 2 in that the display in 5 (k=5, 1≦k<n) continuous divided frame display periods is performed during each image data use period TD. For example, during the image data use period TD where image data data1 is used, the display of 5 divided frame display periods R1, G1, B1, R2, G2 is performed, and the display in remaining 1 (n−k=1) divided frame display period B2 is not performed. Here, image information (a part of image data) used for the display in each divided frame display period is a part of gray level information on color corresponding to each pixel in image data. To be more specific, the gray level information is constituted of gray level values (0 to 255), and the gray level values can be expressed by 8 bits. That is, the gray level information is the combination of values (0, 1) of some orders out of 8 bits (orders). Such combination is determined based on the combination of sub frame periods which constitutes the divided frame display period. For example, during the image data use period TD where image data data1 is used, image information for displaying the divided frame display period B2 is not used. During the image data use period TD where image data data2 is used, image information for displaying the divided frame display period G2 is not used. During the image data use period TD where image data data3 is used, image information for displaying the divided frame display period R2 is not used. That is, in the respective image data use periods TD, a part of image data is not used.

In the same manner as the first embodiment shown in FIG. 6, when the first divided frame display periods of the respective image data are connected to each other, RBGRBG . . . is repeated, and the cumulative colors are recognized as white to a human eye whereby a red colored line which appears on a left side of the strip line is suppressed. In the same manner, when the last divided frame display periods of the respective image data are connected to each other, GRBGRB . . . is repeated so that a blue colored line which appears on the right side of the strip line is suppressed. All of the display on the left side of the strip line, the display in the vicinity of the center of the strip line and the display on a right side of the strip line are performed as W in FIG. 8.

According to the control method of this embodiment, advantageous effects substantially equal to the advantageous effects acquired by the control method according to the first embodiment could be acquired. Further, a part of image data which is not used could be decreased and hence, compared to the first embodiment, the color separation could be suppressed while realizing a display which is closer to an image display which uses all image data amounting to 1 screen.

### Fourth Embodiment

In a fourth embodiment of the present invention, in the same manner as the third embodiment, a 1 frame display period is constituted of 6 (n=6) divided frame display periods. In the same manner as the second embodiment, a 1 image data use period TD is longer than a 1 frame display period TF, and a part of image data is used in a superposing manner during the 1 image data use period TD.

FIG. 9 is a view showing an image display according to this embodiment. An axis of ordinates and an axis of abscissas in the drawing, and three image data data1, data2, data3 are set substantially in the same manner as the image display shown in FIG. 6 to FIG. 8. The 1 image data use period TD is 16.67 ms (frequency: 60 Hz) and is constituted of 7 divided frame display periods. On the other hand, the 1 frame display period TF is 0.857 times as long as the 1 image data use period TD, that is, 14.29 ms (frequency: 70 Hz).

In this embodiment, during each 1 image data use period TD, the display in 7 (k=7, n<k<2n) continuous divided frame display periods is performed. For example, during the image data use period TD where image data data1 is used, in addition to the display in the 1 frame display period TF (divided frame display periods R1, G1, B1, R2, G2, B2) where image data amounting to 1 screen is displayed, the display in a succeeding 1 (k−n) divided frame display period R1 is performed. In the image data use period TD where the image data data1 is used, the display in 6 divided frame display periods R1, G1, B1, R2, G2, B2 is performed using all image data data1 (data amounting to 1 screen) and, further, the display in the divided frame display period R1 is performed using a part of the image data data1 so that a part of gray level information on R which is apart of image data data1 is used in a superposed manner.

During the image data use period TD where the image data data1 is used, in addition to the image display amounting to 1 screen (divided frame display periods R1, G1, B1, R2, G2, B2), the display in the divided frame display period R1 is performed using a part of gray level information on R. During the image data use period TD where the image data data2 is used, in addition to the image display amounting to 1 screen (divided frame display periods G1, B1, R2, G2, B2, R1), the display in the divided frame display period G1 is performed using apart of gray level information on G. During the image data use period TD where the image data data3 is used, in addition to the image display amounting to 1 screen (divided frame display periods B1, R2, G2, B2, R1, G1), the display in the divided frame display period B1 is performed using gray level information on B. Accordingly, in the same manner as the second embodiment shown in FIG. 7, both a red colored line which appears on a left side of the strip line and a blue colored line which appears on a right side of the strip line could be suppressed.

According to the control method of this embodiment, advantageous effects substantially equal to the advantageous effects acquired by the control method according to the second embodiment could be acquired. Further, a part of image data to be used in a superposed manner could be decreased and hence, compared to the second embodiment, the color separation could be suppressed while realizing a display which is closer to an image display which uses all image data amounting to 1 screen.

In the above-mentioned first to fourth embodiments, in the respective n pieces of divided frame display periods which constitute the 1 frame display period TF, a display of any one of three colors of RGB is performed and, further, colors to be displayed in the n pieces of continuous divided frame display periods are regularly (cyclically) repeated in the order of RGB. When the 1 frame display period TF is longer than the image data use period TD, in the image data use period TD, a display of the 1 remaining divided frame display period is not performed so that the color to be displayed in the first (last) divided frame display period during each image data use period TD could be shifted in the order of RBG. When the 1 frame display period TF is shorter than the image data use period TD, in the image data use period TD, the display of another divided frame display period is performed in addition to the display of the 1 frame display period TF (n pieces of divided frame display periods) and hence, the color to be displayed in the first (last) divided frame display period in each image data use period TD could be shifted in the order of RGB. In this manner, by not performing the display of 1 piece of divided frame display period (by performing another display) when the 1 frame display period TF is longer (shorter) than the image data use period TD, the color to be displayed in the first divided frame display period during each image data use period TD could be shifted in order. The number of divided frame display periods where the display is not performed (the display is further performed) is not limited to 1 and may be 2. That is, it is sufficient that the number of such divided frame display periods may be a numeral smaller than the number of kinds of colors (3). It is desirable that the number of divided frame display periods where the display is not performed (the display is further performed) is 1 to realize a display closer to an image display where all image data amounting to 1 screen is used.

### Fifth Embodiment

In a fifth embodiment of the present invention, a 1 frame display period TF is constituted of 12 pieces of divided frame display periods. In the third and fourth embodiments, the 1 frame display period TF is constituted of 6 pieces of divided frame display periods R1, G1, B1, R2, G2, B2. The fifth embodiment is characterized by further dividing each divided frame display period into a front half and a latter half. For example, a front half portion of the divided frame display period R1 is set as a divided frame display period R1A, and a latter half portion of the divided frame display period R1 is set as a divided frame display period R1B.

Also in this embodiment, when the 1 frame display period TF is longer than the image data use period TD, in the image data use period TD, a display of the 1 remaining divided frame display period is not performed so that the first (last) divided frame display period in each image data use period TD could be shifted one by one. In the same manner, when the 1 frame display period TF is shorter than the image data use period TD, in the image data use period TD, the display of another 1 divided frame display period is performed in addition to the display of the 1 frame display period TF (n pieces of divided frame display periods) so that the first (last) divided frame display period in each image data use period TD could be shifted one by one. Here, the latter case is explained.

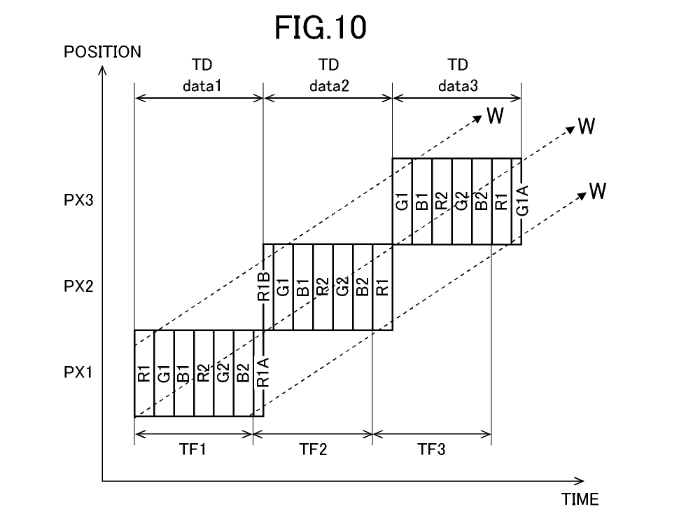

FIG. 10 is a view showing an image display according to this embodiment. An axis of ordinates and an axis of abscissas in the drawing, and three image data data1, data2, data3 are set substantially in the same manner as the image display shown in FIG. 6 to FIG. 9. The 1 image data use period TD is 16.67 ms (frequency: 60 Hz) and is constituted of 13 divided frame display periods. On the other hand, the 1 frame display period TF is 0.923 times as long as the 1 image data use period TD, that is, 15.38 ms (frequency: 65 Hz).

As described above, the 1 frame display period TF is constituted of 12 pieces of divided frame display periods R1A, R1B, G1A, G1B, . . . B2A, B2B. In the image data use period TD where the image data data1 is used, in addition to an image display amounting to 1 screen, a display of the divided frame display period R1A is further performed. In the image data use period TD where the image data data2 is used, in addition to an image display amounting to 1 screen, a display of the divided frame display period R1B is further performed. In the image data use period TD where the image data data3 is used, in addition to an image display amounting to 1 screen, a display of the divided frame display period G1A is further performed. In FIG. 10, for example, two pieces of divided frame display periods R1A, R1B are collectively expressed as R1. The same goes for other divided frame display periods G1, B1, R2, G2, B2.

By performing such an image display, the first (last) divided frame display period in each image data use period TD could be shifted one by one in the order of R1A, R1B, G1A, . . . . In the first to fourth embodiments, the color to be displayed in the first (last) divided frame display period in each image data use period TD is repeated in the order of RGB, and when the image data use period TD is 16.67 ms (frequency: 60 Hz), a color exchange cycle is three times as long as the image data use period TD, that is, 50 ms (frequency: 20 Hz). To the contrary, in this embodiment, the color to be displayed in the first (last) divided frame display period in each image data use period TD is repeated in the order of RRGGBB so that a color exchange cycle is twice as long as the color exchange cycle of the first to fourth embodiments with respect to the same image data use period TD whereby it is not desirable from a view point of the suppression of color separation. However, this embodiment could acquire the following advantageous effects. In the case of the image display shown in FIG. 10, although the 1 frame display period TF is constituted of 12 pieces of divided frame display periods, the repetition of RGB is twice in the 1 frame display period TF in the same manner as FIG. 8 and FIG. 9. That is, by increasing the number (n pieces) of the divided frame display periods, a part of image data to be used in a superposed manner could be decreased whereby a display closer to an image display where image data amounting to 1 screen is used could be realized. Nevertheless, the number of switching the light emission of a light source per unit time could be decreased so that light emitting efficiency is enhanced and power consumption could be reduced.

### Sixth Embodiment

A sixth embodiment of the present invention provides a drive sequence which suppresses the appearance of contouring. This embodiment is characterized by applying the present invention to such a drive sequence.

For example, in performing a display using a drive sequence shown in FIG. 5, a phenomenon referred to as contouring occurs. Here, contouring is a phenomenon where a boundary between brightness and darkness which does not exist actually appears. According to the drive sequence shown in FIG. 5, for example, contouring occurs when a pattern for changing over a gray level from a gray level value of 128 to a gray level value of 127 is scrolled from the right side to the left side on a screen. Firstly, the drive sequence according to this embodiment is explained.

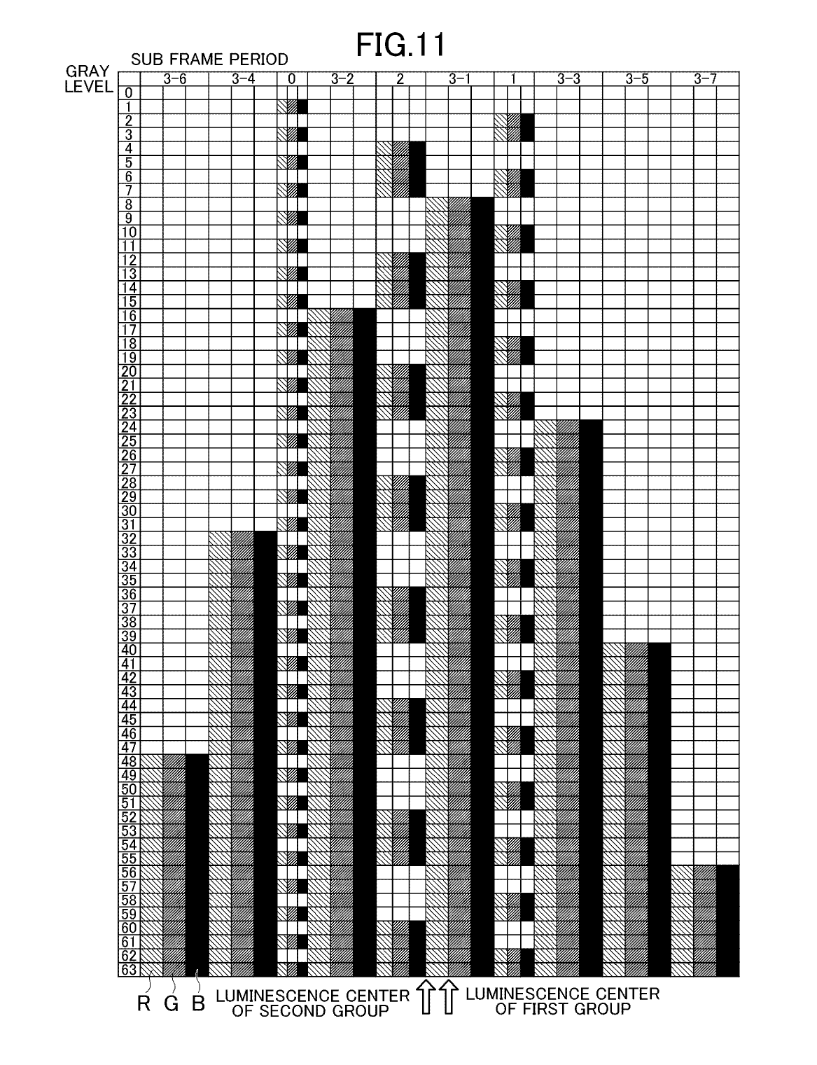

FIG. 11 is a view showing the drive sequence used in this embodiment. A displayable gray level is taken on an axis of ordinates in the drawing, and the gray level number is indicated on the leftmost row. The gray level number is increased in the descending direction in the drawing. Further, a 1 frame display period during which one image is displayed is taken on an axis of abscissas in the drawing. The number of sub frame period which constitutes the 1 frame display period is indicated on the uppermost row. The left side in the drawing corresponds to a start point side of the 1 frame display period, and the right side in the drawing corresponds to a finish point side of the 1 frame display period. Each sub frame period includes light transmission periods of respective colors of RGB. The light transmission periods of respective RGB are equal, and are set to a predetermined length in the respective sub frames. The sub frame period shown in FIG. 4 indicates a light transmission period of any one color of RGB so that the sub frame period shown in FIG. 4 differs from the sub frame period shown in FIG. 11 in this point. In this embodiment, the light transmission periods of respective colors of RGB are repeated at a short cycle in the order of RGB. When an MEMS shutter is used, the light transmission period is a lighting period of the backlight 2 and an open period of the MEMS shutter. This drawing shows the light transmission periods during which the transmission of light is performed in each sub frame period at each gray level. In this manner, the respective gray levels are expressed by the presence or the non-presence of the light transmission period in the sub frame period. Although an example where the gray levels of the respective colors are equal (R=G=B) is shown in these drawings, respective lighting patterns are applied when the gray levels of the respective colors differ from each other. Further, an address period is provided between the respective light transmission periods in an actual operation although not shown in the drawing.

The sub frame periods are classified into the sub frame periods 3-1 to 3-7 belonging to a first group and the sub frame periods 0 to 2 belonging to a second group. In the sub frame periods 3-1 to 3-7 belonging to the first group, lengths of the light transmission periods are equal. The length of the light transmission period is 3 bits in this embodiment. Numeral “3” on a front side of 3-1 to 3-7 expresses that the light transmission period has the length of 3 bits, and numerals “1, 2, 3, 4, 5, 6 and 7” on a rear side respectively indicate the order at which the light transmission period appears in accordance with the increase of the gray level. In the first group, the number of sub frame periods where the light transmission period appears is increased every time the gray level reaches multiples of 8. In the sub frame periods 0 to 2 belonging to the second group, the lengths of the light transmission periods are shorter than the lengths of light transmission periods of the first group, and weighting is applied to the light transmission periods so as to make the lengths of the light transmission periods in the second group and the lengths of the light transmission periods in the first group differ from each other. The lengths of the light transmission periods are 0 to 2 bits in this embodiment. Numeral “0 to 2” expresses that the light transmission period has the length of 0 to 2 bits. In the sub frame periods 0 to 2 belonging to the second group, until the gray level reaches 8, a pattern of the combination of light transmission periods having lengths corresponding to the respective gray levels appears, and this pattern is repeated each time the gray level reaches a multiple of 8. The sub frame periods 3-1 to 3-7 belonging to the first group are also referred to as lighting control parts, and sub frame periods 0 to 2 belonging to the second group are also referred to as bit control part.

Out of the sub frame periods 3-1 to 3-7 belonging to the first group, the number of sub frame periods where the light transmission period appears is increased toward a start point and a finish point from a middle portion of the 1 frame display period along with the elevation of the gray level so that the sub frame periods are arranged so as to form an approximately mountain shape as a whole. Here, the number of sub frame periods where the light transmission period appears is alternately increased toward a start point side and a finish point side. For example, the sub frame period 3-1 where the light transmission period appears at the lowest gray level is provided at a center portion of the 1 frame display period. The sub frame period 3-2 where the light transmission period appears at the second lowest gray level is provided on either a start point side or a finish point side of the 1 frame display period with respect to the sub frame period 3-1. In this example, as shown in FIG. 11, the sub frame period 3-2 is provided on the start point side of the 1 frame display period with respect to the sub frame period 3-1. The sub frame period 3-3 where the light transmission period appears at the third lowest gray level is provided on a side opposite to the sub frame period 3-2 with respect to the sub frame period 3-1. The sub frame period 3-4 where the light transmission period appears on the fourth lowest gray level is provided on the same side as the sub frame period 3-2 with respect to the sub frame period 3-1 and more away from the sub frame period 3-1 than the sub frame period 3-2 is. The succeeding sub frame periods 3-5 to 3-7 are also provided in accordance with such a rule. The same goes for a case where the gray level number is larger than 6 bits.

The sub frame periods 0 to 2 belonging to the second group are respectively provided between the sub frame periods 3-1 to 3-7 belonging to the first group. That is, the sub frame periods 3-1 to 3-7 belonging to the first group and the sub frame periods 0 to 2 belonging to the second group are alternately provided. In this example, the sub frame periods 0 to 2 belonging to the second group are provided close to the center of the 1 frame display period, and out of these sub frame periods 0 to 2, two sub frame periods are provided before and after the sub frame period 3-1 which is arranged at the center portion of the 1 frame display period in a sandwiching manner.

As shown in FIG. 11, the sub frame periods 3-2, 4, 6 are provided on the start point side of the 1 frame display period with respect to the sub frame period 3-1, and the sub frame periods 3-3, 5, 7 are provided on the finish point side of the 1 frame display period with respect to the sub frame period 3-1. As another example, the sub frame periods 3-2, 4, 6 may be provided on the finish point side of the 1 frame display period with respect to the sub frame period 3-1, and the sub frame periods 3-3, 5, 7 may be provided on the start point side of the 1 frame display period with respect to the sub frame period 3-1.

By adopting the drive sequence shown in FIG. 11, both the luminescence center of the first group and the luminescence center of the second group are arranged close to the center of the 1 frame display period thus providing the drive sequence which can suppress the occurrence of contouring. When such a drive sequence is adopted, the color separation which occurs when another image different from the image shown in FIG. 18 is scrolled arises as a more important matter.

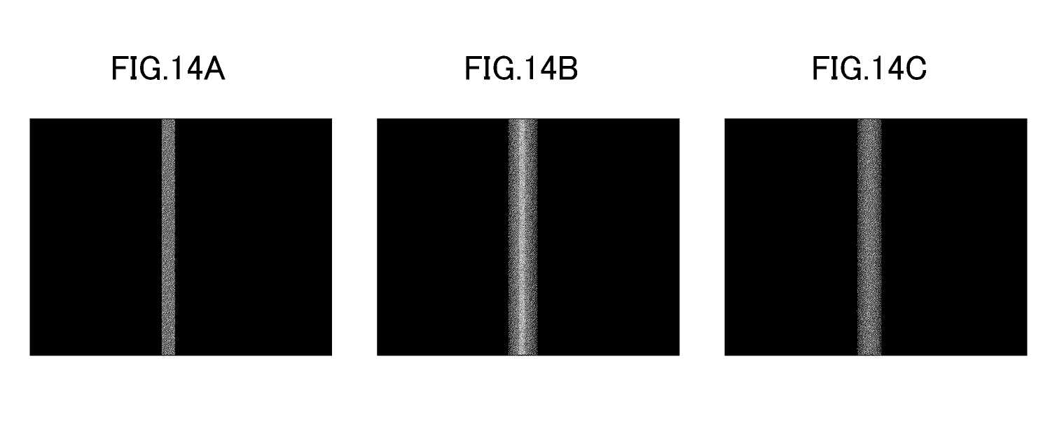

Next, the color separation which occurs due to the drive sequence shown in FIG. 11 is explained. FIG. 14A to FIG. 14C are views showing an image for illustrating an example of color separation according to this embodiment. Here, an image which may cause a problem is an image shown in FIG. 14A. This image is an image having gray levels of 6 bits and also is an image where a strip line having color expressed by gray level values of RGB (63, 7, 7) and having a predetermined width is displayed on a black background. As shown in FIG. 11, at the gray level value of 7, the light transmission is performed in all sub frame periods 0 to 2 (bit control parts) belonging to the second group, and the light transmission is not performed at all in the sub frame periods 3-1 to 3-7 (lighting control parts) belonging to the first group. To the contrary, at the gray level value of 63, the light transmission is performed in all sub frame periods.

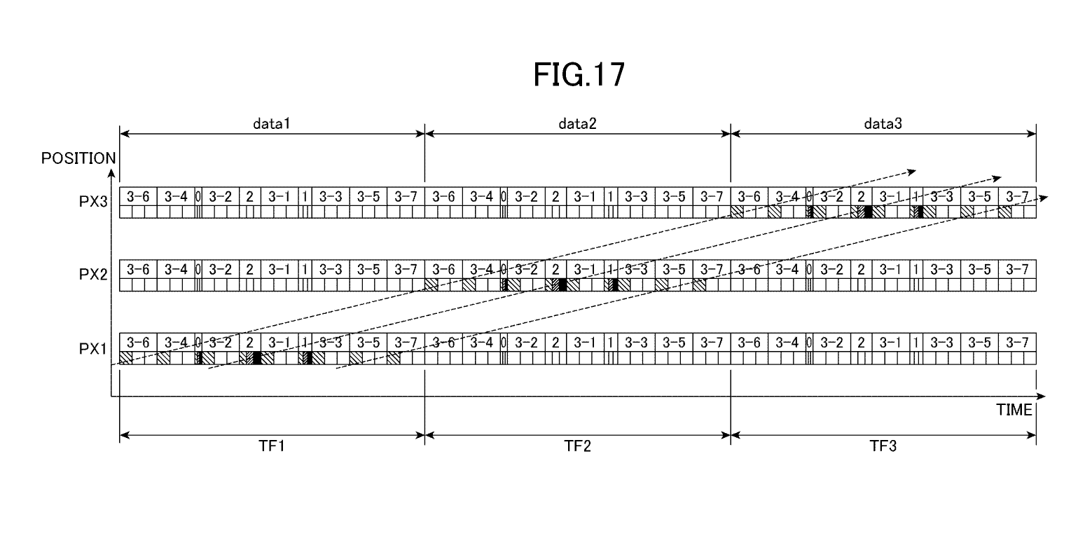

FIG. 17 is a view showing an image display according to a comparison example 3 of the present invention. An axis of ordinates and an axis of abscissas in the drawing are set substantially in the same manner as the image display shown in FIG. 15. In the comparison example 3, a display is performed using the drive sequence shown in FIG. 11. A frame display period is constituted of 7 pieces of sub frame periods 3-1 to 3-7 belonging to a first group and 3 pieces of sub frame periods 0 to 2 belonging to a second group. With respect to image data data1, a pixel PX1 performs a display with color expressed by gray level values (63, 7, 7) of RGB, and a pixel PX2 and a pixel PX3 performs a black display. In the same manner, with respect to image data data2, the pixel PX2 performs a display with the above-mentioned color, and the pixel PX1 and the pixel PX3 perform a black display, and with respect to image data data3, the pixel PX3 performs a display with the above-mentioned color, and the pixel PX1 and the pixel PX2 perform a black display. In the comparison example 3, in the same manner as the comparison example 1 and the comparison example 2, an image data use period TD and a frame display period TF are equal in length. That is, both the lengths of the image data use period TD and the frame display period TF are 16.67 ms (frequency: 60 Hz).

In the display of colors expressed by the gray level values (63, 7, 7) of RGB, only light of R transmits in 7 pieces of sub frame periods 3-1 to 3-7 belonging to the first group, and lights of all three colors of RGB transmit in 3 pieces of sub frame periods 0 to 2 belonging to the second group. As shown in FIG. 17, in each image data use period TD, 3 pieces of sub frame periods 0 to 2 belonging to the second group respectively appear after the same time elapses from starting the periods and hence, 3 pieces of sub frame periods 0 to 2 where the light transmission is performed with respect to all three colors of RGB are recognized as white so that a white colored line appears. FIG. 14B shows an image recognized by a human eye when such an image is displayed by the comparison example 3.

Next, an image display according to this embodiment is explained using the drive sequence shown in FIG. 11. Also in this embodiment, when the 1 frame display period TF is longer than the image data use period TD, by not performing a display in the remaining divided frame display period (forming a part of the image data use period TD) during the image data use period TD, the first (last) divided frame display periods in the respective image data use periods TD can be made different from each other. In the same manner, when the 1 frame display period TF is shorter than the image data use period TD, by performing a further display in the divided frame display period (forming a part of the image data use period TD) in the image data use period TD in addition to the display in the 1 frame display period TF (n pieces of divided frame display periods), the first (last) divided frame display periods in the respective image data use periods TD can be made different from each other. Here, the latter case is explained.

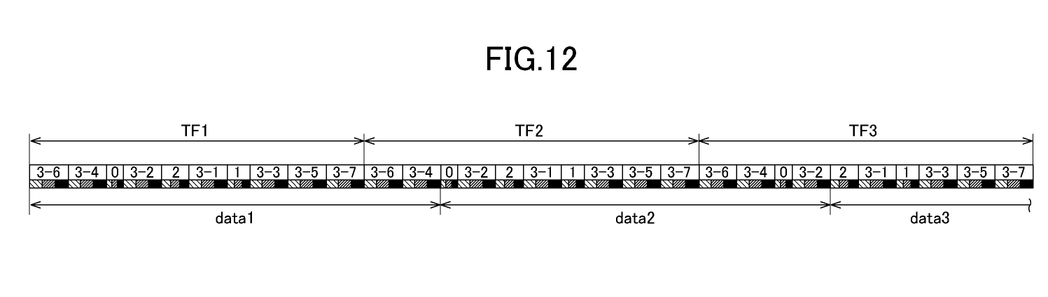

FIG. 12 is a view showing the relationship between the image data use period and the frame display period TF according to this embodiment. Here, a case where the 1 frame display period TF is shorter than a period where each image data is used is shown.

As shown in the drawing, a 1 frame display period is constituted of 10 pieces of sub frame periods. By arranging these sub frame periods time-sequentially such that two sub frame periods are put together, divided frame display periods are provided. That is, the 1 frame display period is constituted of 5 pieces of divided frame display periods. That is, the 1 frame display period is constituted of the first divided frame display period which is formed of the sub frame periods 3-6, 3-4, the second divided frame display period which is formed of the sub frame periods 0, 3-2, the third divided frame display period which is formed of the sub frame periods 2, 3-1, the fourth divided frame display period which is formed of the sub frame periods 1, 3-3, and the fifth divided frame display period which is formed of the sub frame periods 3-5, 3-7 in this order. Here, a length of the divided frame display period differs depending on a kind of a divided frame display period.

As shown in FIG. 12, each frame display period TF is constituted of 5 (n=5) pieces of continuous divided frame display periods, and a display in 6 pieces (k=6, n<k<2n) of continuous divided frame display periods is performed during a period where image data is used (image data use period). In the period where image data is used (image data use period), in addition to the display during the 1 frame display period TF, the display in succeeding 1 piece (k−n) of divided frame display period is performed. The period where the image data is used differs depending on a kind of succeeding one piece of divided frame display period.

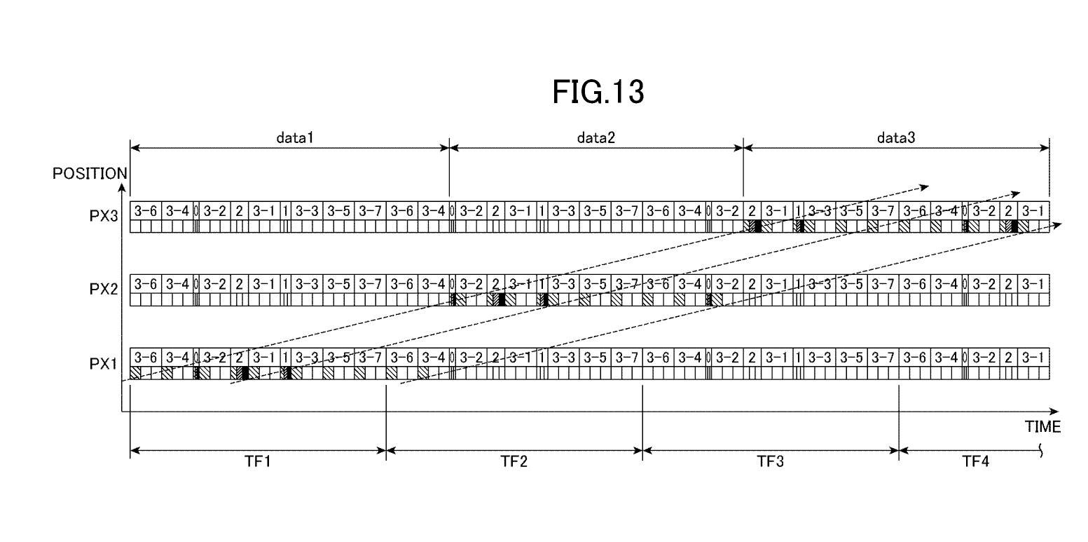

FIG. 13 is a view showing the image display according to this embodiment. Although an axis of ordinates and an axis of abscissas in the drawing are taken in the same manner as the image display shown in FIG. 6 to FIG. 9, three image data data1, data2, data3 are set substantially in the same manner as the comparison example 3 shown in FIG. 17. Image data is fetched at frequency of 60 Hz, and a period where image data is used is 16.67 ms (frequency: 60 Hz) on average, and is constituted of 6 pieces of divided frame display periods. On the other hand, the 1 frame display period TF is 0.833 times as long as the 1 image data use period TD, and is set to 13.89 ms (frequency: 72 Hz).

In the image display according to this embodiment shown in FIG. 13, by performing such an image, display, the appearance of the sub frame periods 0 to 2 where the light transmission of three colors of RGB is performed differs depending on image data to be used from a start of the period where each image data is used. The divided frame display periods which are firstly used in the periods where the image data data1 to data3 are used are constituted of a first divided frame display period, a second divided frame display period and a third divided frame display period in this order, and these divided frame display periods are shifted in order one by one.

For example, the sub frame period 2 is the first sub frame period in the third divided frame display period. In the case of the image display according to the comparison example 3 shown in FIG. 17, the third divided frame display period is always third out of the 5 divided frame display periods in all periods where image data is used (frame display periods). Accordingly, in all periods where image data is used, the sub frame period 2 appears after a lapse of equal time from a start of the respective periods. To the contrary, in the case of the image display according to this embodiment shown in FIG. 13, the third divided frame display period is third, second, and first out of the 5 divided frame display periods in order in the respective periods where image data data1 to data3 are used. Accordingly, in the respective periods where image data data1 to data3 are used, the sub frame period 2 appears after the lapse of different times from a start of the respective periods. Accordingly, the appearance of white colored lines recognized by a human eye due to the sub frame period 2 could be suppressed. The same goes for the sub frame periods 0, 1.

FIG. 14A to FIG. 14C are views showing an image for illustrating an example of color separation, wherein FIG. 14C shows an image recognized by a human eye when such an image is displayed in accordance with this embodiment. As shown in FIG. 14B, a white colored line which appears in accordance with the comparison example 3 is suppressed in FIG. 14C thus exhibiting an advantageous effect in the image display according to this embodiment.

The present invention has been explained in conjunction with the plurality of embodiments heretofore. In the sixth embodiment, the lengths of n pieces of divided frame display periods differ depending on the combination of the sub frame periods which constitutes the divided frame display period. Also in this case, the control part cyclically fetches image data and performs a display based on the fetched image data. The same goes for other embodiments, and the present invention is applicable to other embodiment without problems irrespective of whether lengths of n pieces of divided frame display periods are equal to or different from each other.

Although the display device according to the present invention has been explained as the display device which makes use of lighting control elements such as MEMS shutters, it is needless to say that the present invention is not limited to such a display device, and is broadly applicable to a display device which performs a display using a color sequential driving method.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A display device comprising:
a light source of plural kinds of colors;
a plurality of elements which are provided to a plurality of pixels respectively, and change over transmission/non-transmission of light emitted from the light source; and
a control part which expresses gray levels of the respective pixels by color sequential driving in which the presence/non-presence of lighting of the light source and the transmission/non-transmission of light by the elements are sequentially controlled, wherein:
the control part fetches image data amounting to 1 screen and performs a display based on the image data for every image data use period, and performs a display of an image amounting to 1 screen for every frame display period; and
the frame display period differs from the image data use period in length.

2. The display device according to claim 1, wherein the control part does not use a part of the image data during the image data use period when the frame display period is longer than the image data use period, and the control part uses a part of the image data during the image data use period in a superposed manner when the frame display period is shorter than the image data use period.

3. The display device according to claim 1, wherein:
the frame display period is constituted of n (n≧2) pieces of continuous divided frame display periods;
a display in k (1≦k<n) pieces of continuous divided frame display periods is performed during 1 image data use period; and
during the 1 image data use period, the control part does not use a part of the image data to be used for a display in remaining (n−k) pieces of divided frame display periods.

4. The display device according to claim 1, wherein:
the frame display period is constituted of n (n≧2) pieces of continuous divided frame display periods;
a display in k (n<k<2n) pieces of continuous divided frame display periods is performed during 1 image data use period; and
during the 1 image data use period, the control part uses the image data amounting to 1 screen during 1 frame display period, and further uses a part of the image data which is used for a display in further succeeding (k−n) pieces of divided frame display periods.

5. The display device according to claim 3, wherein:
a display with only any one of the plural kinds of colors is performed in the n pieces of continuous divided frame display periods respectively, and kinds of colors which are displayed during the n pieces of divided frame display periods are sequentially repeated; and
(n−k) is smaller than the number of kinds of colors.

6. The display device according to claim 4, wherein:
a display with only any one of the plural kinds of colors is performed in the n pieces of continuous divided frame display periods respectively, and kinds of colors which are displayed during the n pieces of divided frame display periods are sequentially and repeatedly continued; and
(k−n) is smaller than the number of kinds of colors.

7. The display device according to claim 3, wherein:
each of the n pieces of divided frame display periods is constituted of 1 or plural sub frame periods, and a predetermined length of a light transmission period where transmission/non-transmission of light by the element is allowed is determined with respect to the plurality of respective sub frame periods;
the plurality of sub frame periods which constitute the frame display period are classified into a first group to which the sub frame periods having light transmission periods of the same length belong and a second group to which the sub frame periods having light transmission periods which are shorter than the light transmission periods of the sub frame periods of the first group in length and differ from each other belong;
the plurality of sub frame periods belonging to the first group are arranged in the frame display period so that the number of sub frame periods having the light transmission periods is increased toward a start point and a finish point of the frame display period from a middle portion of the frame display period along with the elevation of the gray level; and
each of the plurality of sub frame periods includes the plurality of light transmission periods in which lights of various kinds of colors transmit.

8. The display device according to claim 4, wherein:
each of the n pieces of divided frame display periods is constituted of 1 or plural sub frame periods, and a predetermined length of a light transmission period where transmission/non-transmission of light by the element is allowed is determined with respect to the plurality of respective sub frame periods;
the plurality of sub frame periods which constitute the frame display period are classified into a first group to which the sub frame periods having light transmission periods of the same length belong and a second group to which the sub frame periods having light transmission periods which are shorter than the light transmission periods of the sub frame periods of the first group in length and differ from each other belong;
the plurality of sub frame periods belonging to the first group are arranged in the frame display period so that the number of sub frame periods having the light transmission periods is increased toward a start point and a finish point of the frame display period from a middle portion of the frame display period along with the elevation of the gray level; and
each of the plurality of sub frame periods includes the plurality of light transmission periods in which lights of various kinds of colors transmit.

9. The display device according to claim 7, wherein the sub frame periods belonging to the first group and the sub frame periods belonging to the second group are alternately provided.

10. The display device according to claim 7, wherein the sub frame periods belonging to the second group are provided before and after the sub frame period having the light transmission period at the lowest gray level out of the sub frame periods belonging to the first group.

11. A control method of a display device which comprises:
a light source of plural kinds of colors;
a plurality of elements which are provided to a plurality of pixels respectively, and change over transmission/non-transmission of light emitted from the light source; and
a control part which expresses gray levels of the respective pixels by color sequential driving in which the presence/non-presence of lighting of the light source and the transmission/non-transmission of light by the elements are sequentially controlled, wherein:
the control part fetches image data amounting to 1 screen and performs a display based on the image data for every image data use period, and performs a display of an image amounting to 1 screen for every frame display period; and
the frame display period differs from the image data use period in length.

12. The control method of a display device according to claim 11, wherein the control part does not use a part of the image data during the image data use period when the frame display period is longer than the image data use period, and the control part uses a part of the image data during the image data use period in a superposed manner when the frame display period is shorter than the image data use period.

13. The control method of a display device according to claim 11, wherein:
the frame display period is constituted of n (n≧2) pieces of continuous divided frame display periods;
a display in k (1≦k<n) pieces of continuous divided frame display periods is performed during 1 image data use period; and
during the 1 image data use period, the control part does not use a part of the image data to be used for a display in remaining (n−k) pieces of divided frame display periods.

14. The control method of a display device according to claim 11, wherein:
the frame display period is constituted of n (n≧2) pieces of continuous divided frame display periods;
a display in k (n<k<2n) pieces of continuous divided frame display periods is performed during 1 image data use period; and
during the 1 image data use period, the control part uses the image data amounting to the 1 screen during 1 frame display period, and further uses a part of the image data which is used for a display in further succeeding (k−n) pieces of divided frame display periods.

15. The control method of a display device according to claim 13, wherein:
a display with only any one of the plural kinds of colors is performed in the n pieces of continuous divided frame display periods respectively, and kinds of colors which are displayed during the n pieces of divided frame display periods are sequentially repeated; and
(n−k) is smaller than the number of kinds of colors.

16. The control method of a display device according to claim 14, wherein:
a display with only any one of the plural kinds of colors is performed in the n pieces of continuous divided frame display periods respectively, and kinds of colors which are displayed during the n pieces of divided frame display periods are sequentially and repeatedly continued; and
(k−n) is smaller than the number of kinds of colors.

17. The control method of a display device according to claim 13, wherein:
each of the n pieces of divided frame display periods is constituted of 1 or plural sub frame periods, and a predetermined length of a light transmission period where transmission/non-transmission of light by the element is allowed is determined with respect to the plurality of respective sub frame periods;
the plurality of sub frame periods which constitute the frame display period are classified into a first group to which the sub frame periods having light transmission periods of the same length belong and a second group to which the sub frame periods having light transmission periods which are shorter than the light transmission periods of the sub frame periods of the first group in length and differ from each other belong;
the plurality of sub frame periods belonging to the first group are arranged in the frame display period so that the number of sub frame periods having the light transmission periods is increased toward a start point and a finish point of the frame display period from a middle portion of the frame display period along with the elevation of the gray level; and
each of the plurality of sub frame periods includes the plurality of light transmission periods in which lights of various kinds of colors transmit.

18. The control method of a display device according to claim 14, wherein:
each of the n pieces of divided frame display periods is constituted of 1 or plural sub frame periods, and a predetermined length of a light transmission period where transmission/non-transmission of light by the element is allowed is determined with respect to the plurality of respective sub frame periods;
the plurality of sub frame periods which constitute the frame display period are classified into a first group to which the sub frame periods having light transmission periods of the same length belong and a second group to which the sub frame periods having light transmission periods which are shorter than the light transmission periods of the sub frame periods of the first group in length and differ from each other belong;
the plurality of sub frame periods belonging to the first group are arranged in the frame display period so that the number of sub frame periods having the light transmission periods is increased toward a start point and a finish point of the frame display period from a middle portion of the frame display period along with the elevation of the gray level; and
each of the plurality of sub frame periods includes the plurality of light transmission periods in which lights of various kinds of colors transmit.

19. The control method of a display device according to claim 17, wherein the sub frame periods belonging to the first group and the sub frame periods belonging to the second group are alternately provided.

20. The control method of a display device according to claim 17, wherein the sub frame periods belonging to the second group are provided before and after the sub frame period having the light transmission period at the lowest gray level out of the sub frame periods belonging to the first group.
